(19) United States
(12) Patent Application Publication
(10) Pub. No.: US 2011/0299533 A1
(43) Pub. Date: Dec. 8, 2011

(54) INTERNAL VIRTUAL NETWORK IDENTIFIER AND INTERNAL POLICY IDENTIFIER

(75) Inventors: Shunjia Yu, San Jose, CA (US); Anoop Ghanwani, Rocklin, CA (US); Phanidhar Koganti, Sunnyvale, CA (US); Mythilikanth Raman, San Jose, CA (US); Rajiv Krishnamurthy, San Jose, CA (US); John Michael Terry, San Jose, CA (US); Wing Cheung, Fremont, CA (US); Joseph Juh-En Cheng, Palo Alto, CA (US); Surya P. Varanasi, Dublin, CA (US)

(73) Assignee: BROCADE COMMUNICATIONS SYSTEMS, INC., San Jose, CA (US)

(21) Appl. No.: 13/050,102

(22) Filed: Mar. 17, 2011

Related U.S. Application Data
(60) Provisional application No. 61/352,731, filed on Jun. 8, 2010.
(60) Provisional application No. 61/381,353, filed on Sep. 9, 2010.

(51) Int. Cl. H04L 12/56

(52) U.S. Cl. 370/392

(57) ABSTRACT

Systems and techniques for processing and forwarding packets are described. Some embodiments provide a system (e.g., a switch) which determines an internal virtual network identifier and/or an internal policy identifier for a packet based on a port on which the packet was received and/or one or more fields in the packet. The system can then process and forward the packet based on the internal virtual network identifier and/or internal policy identifier. In some embodiments, the system encapsulates the packet in a TRILL (Transparent Interconnection of Lots of Links) packet by adding a TRILL header to the packet. In some embodiments, the scope of an internal virtual network identifier and/or an internal policy identifier may not extend beyond a switch or a module within a switch.

### RELATED APPLICATION

This application claims priority to U.S. Provisional Application No. 61/352,731, Attorney Docket Number BRCD-3044.0.1.US.PSP, entitled “Internal Virtual Private Network Identifier,” by inventors Shunjia Yu, Anoop Ghanwani, Phanidhar Koganti, Mythilikanth Raman, Rajiv Krishnamurthy, John Michael Terry, Wing Cheung, Joseph Juh-En Cheng, and Surya P. Varanasi, filed Jun. 8, 2010, the contents of which are herein incorporated by reference.

This application also claims priority to U.S. Provisional Application No. 61/381,353, Attorney Docket Number BRCD-3044.0.2.US.PSP, entitled “Internal Virtual Network Identifier,” by inventors Shunjia Yu, Anoop Ghanwani, Phanidhar Koganti, Mythilikanth Raman, Rajiv Krishnamurthy, John Michael Terry, Wing Cheung, Joseph Juh-En Cheng, and Surya P. Varanasi, filed Sep. 9, 2010, the contents of which are herein incorporated by reference.

### BACKGROUND

1. Technical Field

This disclosure relates to computer networking. More specifically, this disclosure relates to systems and techniques for determining and using an internal virtual network identifier.

2. Related Art

Computer networks have become critical elements of a company's information technology infrastructure. The insatiable demand for bandwidth and the ever increasing size and complexity of computer networks has created a need for increasing the bandwidth and improving manageability of computer networks.

The manageability of computer networks can be improved by using network virtualization. In network virtualization, a large and complex network can be carved up into multiple virtual networks to facilitate manageability. Unfortunately, improving manageability using this approach can increase the amount of processing and resources required at each switch.

### SUMMARY

Some embodiments of the present invention provide systems and techniques for processing and forwarding packets. Specifically, some embodiments provide a system (e.g., a switch) which determines an internal virtual network identifier for a packet based on a port on which the packet was received and/or one or more fields in the packet (e.g., one or more fields in the packet's header). In this disclosure, unless otherwise stated, the phrase “based on” means “based solely or partly on.” The system then forwards the packet based on the internal virtual network identifier. In some embodiments, the system encapsulates the packet in a TRILL (Transparent Interconnection of Lots of Links) packet by adding a TRILL header to the packet, and then forwards the TRILL packet based on the internal virtual network identifier.

In some embodiments, the scope of an internal virtual network identifier may not extend beyond a switch or a forwarding module within a switch. As a packet traverses through different switches in the network, each switch may determine a different internal virtual network identifier.

The one or more fields in the packet can include a customer VLAN (Virtual Local Area Network) identifier, a service provider VLAN identifier, a source MAC (medium access control) address, and a VPN (Virtual Private Network) identifier.

Some embodiments of the present invention provide a network which includes at least one source switch, one or more intermediate switches, and at least one destination switch. A source switch may determine a first internal virtual network identifier for a packet based on one or more fields in the packet. Next, the source switch may encapsulate the packet in a TRILL packet by adding a TRILL header to the packet, and forward the TRILL packet based on the first internal virtual network identifier. The packet may pass through one or more intermediate switches before reaching the destination switch. Each intermediate switch may forward the TRILL packet based on the TRILL header. When the TRILL packet reaches the destination switch, the destination switch may determine a second internal virtual network identifier for the packet encapsulated in the TRILL packet based on one or more fields in the packet. The destination switch may then forward the packet based on the second internal virtual network identifier.

In some embodiments, the system can determine an internal policy identifier for a packet based on a port on which the packet was received and/or one or more fields in the packet. The system can then process the packet according to a policy associated with the internal policy identifier. Packets from different virtual networks can be mapped to the same internal policy identifier if the packets from these virtual networks are desired to be processed according to the same policy. A policy can generally include an arbitrary set of rules which specify how a packet is to be processed within the system. When a system processes a packet according to a given policy, the system can perform one or more actions, which can include, but are not limited to: dropping the packet, routing the packet over a particular link or path, and/or modifying information in the packet. The particular policy-based action that is performed on a packet can depend on information stored in the packet, and can override a forwarding decision that was made for the packet.

In some embodiments, the system can determine an internal virtual network identifier and/or an internal policy identifier for a packet based on one of the following field combinations: (1) the MAC source address and the customer VLAN identifier, (2) customer VLAN identifier, (3) customer VLAN identifier and the service provider VLAN identifier, (4) service provider VLAN identifier, (5) customer VLAN identifier and the VPN identifier, and (6) the VPN identifier. In some embodiments, the system can map a TRILL packet to a default internal virtual network identifier or a default internal policy identifier.

### BRIEF DESCRIPTION OF THE FIGURES

FIG. 1 illustrates a TRILL network in accordance with some embodiments of the present invention.

FIG. 2 illustrates a portion of an Ethernet packet which includes a TRILL header in accordance with some embodiments of the present invention.

FIG. 3 illustrates a switch in accordance with some embodiments of the present invention.

FIG. 4A presents a flowchart that illustrates a process for forwarding packets based on an internal virtual network identifier in accordance with some embodiments of the present invention.

FIG. 4B presents a flowchart that illustrates a process for applying a policy to a packet based on an internal policy identifier in accordance with some embodiments of the present invention.

FIG. 5 illustrates a system in accordance with some embodiments of the present invention.

FIG. 6A illustrates an exemplary mapping between packet header information and internal virtual network identifiers in accordance with some embodiments of the present invention.

FIG. 6B illustrates examples of mappings between packet header information and internal policy identifiers in accordance with some embodiments of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

### TRILL (Transparent Interconnection of Lots of Links)

TRILL combines the advantages of bridging and routing. Bridges (e.g., devices that perform layer-2 forwarding) can transparently connect multiple links to create a single local area network. Without TRILL, bridges use the spanning tree protocol (STP) which restricts the topology on which traffic is forwarded to a tree to prevent loops. Unfortunately, forwarding the traffic over a tree causes traffic concentration on the links that correspond to the tree edges, leaving other links completely unutilized. Unlike bridges, Internet Protocol (IP) routers (e.g., devices that perform IP forwarding) do not need to create a spanning tree for forwarding traffic. However, routers that forward IP traffic require more configuration than bridges, and moving nodes in an IP network requires changing the IP address of the nodes. Each link in an IP network is associated with an address prefix, and all nodes on that link must have that IP prefix. If a node moves to another link that has a different IP prefix, the node must change its IP address. Unless otherwise stated, the term “IP” refers to both “IPv4” and “IPv6” in this disclosure.

A TRILL network includes “routing bridges” (referred to as RBridges) which route packets, but like bridges, learn layer-2 address locations through receipt of packets. Since packets are routed, packet forwarding is not limited to a spanning tree. Also, since a hop count is included in a TRILL packet, packets do not circulate forever in the network in the presence of loops. Further, since the layer-2 address locations are learned, a TRILL network allows IP nodes to move from one link to another in the network without any restrictions.

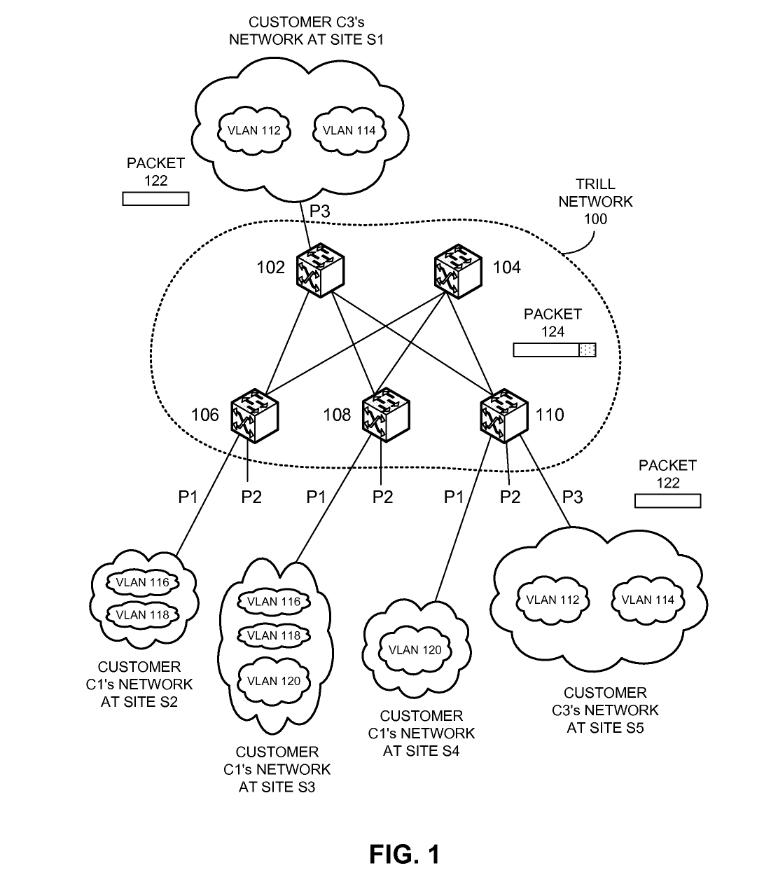

FIG. 1 illustrates a TRILL network in accordance with some embodiments of the present invention. TRILL network 100 can be a service provider's network which includes core RBridges 102 and 104 and edge RBridges 106, 108, and 110. RBridges 102, 106, 108, and 110 are coupled to customer devices, whereas RBridge 104 is not. Specifically, port P3 on RBridge 102 can be coupled to a device in customer C3's network at site S1; ports labeled P1 on RBridges 106, 108, and 110 can be coupled to devices in customer C1's networks at sites S2, S3, and S4, respectively; and port P3 on RBridge 110 can be coupled to a device in customer C3's network at site S5. Note that the port numbers in FIG. 1 match the customer numbers, i.e., ports labeled P1 are associated with customer C1, ports labeled P3 are associated with customer C3, etc. This has been done for ease of discourse. In general, any port on any RBridge can potentially be assigned to one or more virtual networks that are associated with one or more customers.

A virtual local area network (VLAN) in a customer's network may span multiple customer sites. For example, VLANs 112 and 114 in customer C3's network include nodes in sites S1 and S5. Similarly, VLANs 116 and 118 in customer C1's network include nodes in sites S2 and S3, and VLAN 120 in customer C1's network includes nodes in sites S3 and S4.

Nodes that belong to the same VLAN, but which are located at different sites, can communicate with each other transparently through TRILL network 100. Specifically, the ingress RBridge can encapsulate a packet (e.g., an Ethernet packet with or without one or more VLAN tags) received from a customer and route the packet within TRILL network 100 using a TRILL header. The egress RBridge can then strip the TRILL header and send the original customer packet on the appropriate port. For example, packet 122 can originate in customer C3's network at site S1, and be received on port P3 of RBridge 102 with a VLAN tag associated with VLAN 112. Next, RBridge 102, which is the ingress RBridge for this packet, can encapsulate packet 122 by adding a TRILL header to obtain packet 124 (the TRILL header is the shaded portion in packet 124). Next, the TRILL header of packet 124 can be used to route packet 124 through TRILL network 100 until packet 124 reaches RBridge 110, which is the egress RBridge for the packet. RBridge 110 can then strip away the TRILL header on packet 124 to obtain the original packet 122, and send packet 122 on port P3 so that the packet can be delivered to the intended destination in VLAN 112 in customer C3's network at site S5. In FIG. 1, the packet that is received at the ingress RBridge and the packet that is sent from the egress RBridge are shown to be the same. However, these packets can be different. For example, if VLAN translation is being performed, then the packet that is received at the ingress RBridge and the packet that is sent from the egress RBridge can have different VLAN tags.

Details of the TRILL packet format and RBridge forwarding can be found in IETF draft “RBridges: Base Protocol Specification,” available at http://tools.ietf.org/html/draft-ietf-trill-rbridge-protocol-16, which is incorporated herein by reference.

Although some examples in this disclosure are presented in the context of a TRILL network that includes RBridges, the present invention is not limited to TRILL networks or RBridges. The terms “frame” or “packet” generally refer to a group of bits. The use of the term “frame” is not intended to limit the present invention to layer-2 networks. Similarly, the use of the term “packet” is not intended to limit the present invention to layer-3 networks. Unless otherwise stated, the terms “frame” or “packet” may be substituted with other terms that refer to a group of bits, such as “cell” or “datagram.”

### Network Virtualization

Network virtualization enables a service provider to provision virtual networks (VNs) over a common network infrastructure. To a user on a VN it appears as if the traffic is being carried over a separate network that has been specifically built for the user. However, in reality, the traffic from multiple VNs may be carried over a common network infrastructure.

Network virtualization has many uses. For example, network virtualization can be used to create multiple, logically distinct networks on the same physical network to comply with government regulations. Other uses of network virtualization include, but are not limited to, partitioning network resources between different organizations in a company thereby reducing network costs and simplifying network management.

One approach for addressing the problem that is solved by network virtualization is to duplicate resources (e.g., routers, switches, etc.) in the network so that the resources can be provisioned on a per-customer basis. However, this approach is impractical because it is costly and it is not scalable.

Some embodiments of the present invention implement network virtualization and/or partitioning in the TRILL network by embedding a VPN identifier in a TRILL option field in the TRILL header. Specifically, the ingress RBridge can determine a VPN identifier for each packet it receives from a customer, and embed the VPN identifier in a TRILL option field in the TRILL header. Next, the VPN idenifier can be used to support network virtualization and/or partitioning in the TRILL network. Specifically, once the VPN identifier is embedded into the TRILL header, RBridges in the TRILL network can use the VPN identifier to determine how to handle the packet.

In some embodiments, the system can use a service provider VLAN identifier to implement network virtualization and/or partitioning. Specifically, ingress RBridges can add appropriate S-tags to packets received from customers (note that the S-tag based approach may not work for incoming packets that already have an S-tag). Next, the S-tag can be used to implement virtualization and/or partitioning in the network.

### Packet Format

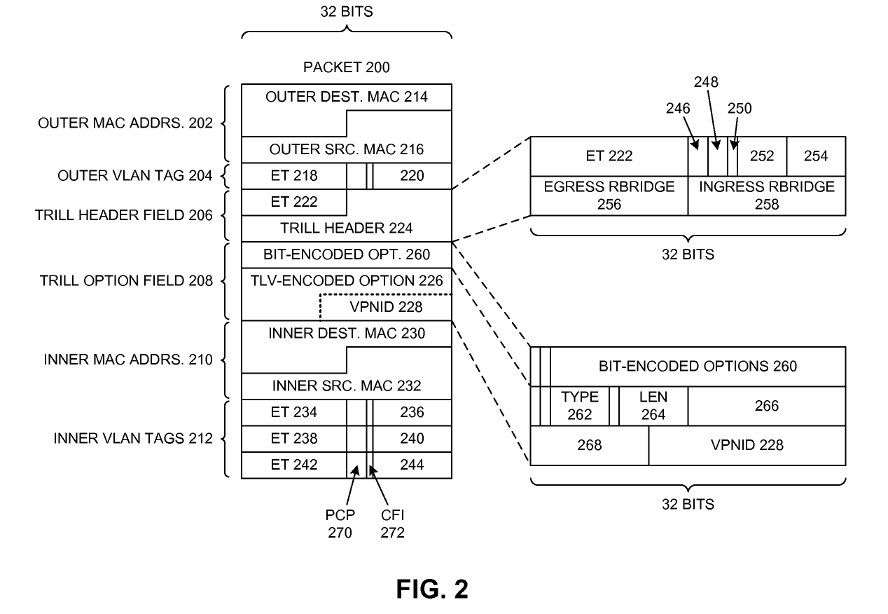

FIG. 2 illustrates a portion of an Ethernet packet which includes a TRILL header in accordance with some embodiments of the present invention. The packet shown in FIG. 2 is for illustration purposes only, and is not intended to limit the present invention.

Packet 200 can include one or more of the following fields: outer MAC (medium access control) addresses 202, outer VLAN tag 204, TRILL header field 206, TRILL option field 208, inner MAC addresses 210, and inner VLAN tags 212. Typically, the packet is transmitted from top to bottom, i.e., the bits associated with outer MAC addresses 202 will appear on the transmission medium before the bits associated with outer VLAN tag 204 appear on the transmission medium, and so forth. The contents of these fields and their uses are discussed below.

Outer MAC addresses 202 can include outer destination MAC address 214 and outer source MAC address 216. These MAC addresses and outer VLAN tag 204 typically change at each TRILL hop as the packet traverses the service provider's network. Specifically, at each hop, outer source MAC address 216 is associated with the MAC address of the source node (e.g., RBridge) for that hop, outer destination MAC address 214 is associated with the MAC address of the destination node (e.g., RBridge) for that hop, and outer VLAN tag 204 is associated with the VLAN that includes the source node and the destination node for that hop.

Outer VLAN tag 204 can include Ethernet type field 218 and outer VLAN identifier 220. The value of Ethernet type field 218 can indicate that the next field is a VLAN identifier. VLAN identifier 220 can be used in the service provider's network to create multiple broadcast domains.

TRILL header field 206 can include Ethernet type field 222 and TRILL header 224. The value of Ethernet type field 222 can indicate that the next field is a TRILL header. TRILL header 224 can include information for routing the packet through a TRILL network that is embedded in the service provider's network. Specifically, as shown in FIG. 2, TRILL header 224 can include version field 246 which indicates the TRILL version, reserved field 248 which may be reserved for future use, multicast field 250 which indicates whether this packet is a multicast packet, TRILL option length 252 which indicates the length (in terms of 32-bit words) of any TRILL option field that follows the TRILL header, and hop count 254 which may be decremented at each RBridge as the packet traverses the service provider's network.

TRILL header 224 also includes egress RBridge nickname 256 and ingress RBridge nickname 258. Ingress RBridge nickname 258 corresponds to the ingress RBridge which receives the packet from the customer's network, and, for unicast packets, egress RBridge nickname 256 corresponds to the egress RBridge which sends the packet to the customer's network. For multicast packets, egress RBridge nickname 256 corresponds to the RBridge which is the root of the multicast tree on which the packet is to be forwarded. For example, in FIG. 1, when packet 122 is received at ingress RBridge 102, ingress RBridge 102 can use the header information in packet 122 to determine that packet 122 needs to be routed to egress RBridge 110. Next, ingress RBridge 102 can add TRILL header field 206 to packet 122 to obtain packet 124. Specifically, RBridge 102 can set ingress RBridge nickname 258 in packet 124's TRILL header to RBridge 102's nickname, and set egress RBridge nickname 256 in packet 124's TRILL header to RBridge 110's nickname. RBridge 102 can then forward packet 124 based solely or partly on packet 124's TRILL header.

TRILL option field 208 can include bit-encoded options and one or more options encoded in a TLV (type-length-value) format. Specifically, TRILL option field 208 can include bit-encoded options 260 which are one-bit option flags, and TLV-encoded option 226. For example, a 20-bit VPN identifier can be encoded as a TLV-encoded option. Specifically, the value of type field 262 can indicate that this option specifies a VPN identifier. Length field 264 can indicate the length of the data portion of the TLV-encoded option in octets. In the packet shown in FIG. 2, TLV-encoded option 226 is used for specifying a 20-bit VPN identifier, and length field 264 is set to the value 0×6. The data portion of TLV-encoded option 226 begins immediately after length field 264. Specifically, in the packet shown in FIG. 2, the total length (in octets) of fields 266, 268, and 228 is equal to 0×6 as specified by length field 264. Further, as shown in FIG. 2, the last 20 bits of the data portion in TLV-encoded option 226 can be used for specifying VPN identifier 228.

Note that a 20-bit VPN identifier can be specified using a smaller data portion, e.g., only 0×3 octets instead of 0×6 octets. However, some embodiments use the following non-obvious insight: it may be desirable to align the 20-bit VPN identifier with the word boundary to simplify chip design and/or to improve performance. Thus, in some embodiments, 0×6 octets are used instead of 0×3 octets so that the 20-bit VPN identifier is aligned with a 32-bit word boundary. For example, as shown in FIG. 2, VPN identifier 228 is aligned with the 32-bit word boundary.

Inner MAC addresses 210 can include inner source MAC address 232 and inner destination MAC address 230 Inner MAC addresses 210 can be the MAC addresses that were present in the header of the packet that was received from the customer's network. For example, in FIG. 1, suppose a source node in VLAN 112 in customer C3's network at site S1 sends a packet to a destination node in VLAN 112 in customer C3's network at site S5. In this scenario, inner source MAC address 232 can correspond to the source node at site S1, and inner destination MAC address 230 can correspond to the destination node at site S5.

Inner VLAN tags 212 can include one or more VLAN tags. For example, inner VLAN tags 212 can include an S-tag which includes Ethernet type field 234 and S-VLAN-identifier 236, a C-tag which includes Ethernet type field 238 and C-VLAN-identifier 240, and another tag which includes Ethernet type field 242 and VLAN identifier 244. Each VLAN tag in outer VLAN tag 204 and inner VLAN tags 212 can also include a three-bit Priority Code Point (PCP) field (also referred to as the “priority” or “priority bits” in this disclosure), e.g., PCP 270, and a one-bit CFI field, e.g., CFI 272. When an S-tag is used, the CFI field can carry a drop eligibility indicator (DEI) bit. The values in Ethernet type fields (e.g., 234, 238, and 242) can indicate the type of VLAN tag that follows. For example, Ethernet type field 234 and 238 can indicate a VLAN identifier for an S-tag and a VLAN identifier for the C-tag follow the respective Ethernet type fields. The S-tag and the C-tag can be used by the customer to create a stacked-VLAN architecture, e.g., as defined in the Provider Bridging standard. The S-tag may also be used by the service provider to implement network virtualization and/or partitioning. Packet 200 can also include other tags, each tag having a tag-type field which indicates the type of the tag, and a field that stores contents (e.g., an identifier) related to the tag. For example, packet 200 can include a 32-bit congestion-notification-tag (CN-tag) which includes a 16-bit tag-type field and a 16-bit flow-identifier. The congestion-notification-tag may be used by the customer to manage network congestion.

Note that a packet may or may not include all of the fields shown in FIG. 2. For example, in some embodiments, a packet may not include one or more of inner VLAN tags 212 and/or outer VLAN tag 204. Further, certain combinations of fields may not be allowed in some embodiments. For example, in some embodiments, a packet may include either an S-tag or a TRILL option field, but not both. Additionally, the values of some fields may be related to each other. For example, in some embodiments, S-VLAN-identifier 236 may be copied into the 12 least significant bits of VPNID 228.

VLAN tagging is specified in IEEE (Institute of Electrical and Electronics Engineers) standard IEEE 802.1 Q. The earlier versions of the standard, including and up to IEEE 802.1Q-2005 of this standard describes how a single VLAN tag can be added to an Ethernet packet to create multiple broadcast domains within the same local area network (LAN). The term Provider Bridging refers to an amendment of this standard which allows an S-tag (a service VLAN tag is sometimes referred to as a provider tag) to be stacked in a single Ethernet packet. Provider Bridging enables a service provider to carry VLAN traffic from multiple customers on a shared network infrastructure without restricting the VLAN address space available to each customer. Further details on Provider Bridging can be found in the specification for standard IEEE 802.1ad.

In some embodiments, the system can add a TRILL header to a Provider Bridging packet. In these embodiments, the packet received from the customer network may include an S-tag. The service provider's network may then add a TRILL header to the packet. In some embodiments, the system may ensure that the priority bits in the outermost VLAN tag are the same as the priority bits in the S-tag.

### Internal Virtual Network Identifier

When a packet is received on an input port, the packet header is processed by the switch to determine the output port on which the packet is to be forwarded. Oftentimes, the forwarding mechanism (e.g., an integrated circuit specifically designed for performing forwarding lookups) is the bottleneck in the data path. Consequently, increasing the processing speed and decreasing the size and complexity of the forwarding mechanism is usually very important.

One approach for supporting network virtualization in an RBridge is to directly use the VPN identifier and/or other fields in the packet header to perform forwarding lookup. Unfortunately, this approach can require the forwarding mechanism to use a large number of bits to perform the forwarding lookups. As a result, it can be very costly to design a switch that performs forwarding using this approach.

Some embodiments of the present invention determine an internal virtual network identifier based on the port on which a packet is received and/or one or more fields (which may include the VPN identifier) in the packet. Next, the packet is forwarded based on the internal virtual network identifier. The length (in terms of bits) of the internal virtual network identifier can be less than the combined length of the one or more fields in the packet that are used for determining the internal virtual network identifier. This reduction in length can increase the processing speed of the forwarding mechanism, and decrease the overall size and complexity of the implementation.

There are at least two non-obvious insights that allow us to map the one or more fields in the packet to a shorter sized internal virtual network identifier without significantly affecting network virtualization functionality. The first non-obvious insight is that, even though each customer is given the capability to create a large number of virtual networks, it is unlikely that each and every customer will provision a large number of virtual networks. For example, even though each customer may be given the capability to create 4K VLANs, it is unlikely that each and every customer will provision 4K VLANs. Hence, the internal virtual network identifier does not have to be long enough to handle cases in which each customer provisions 4K VLANs. Note that the entire 4K VLAN address space is still available to each customer.

The second non-obvious insight is that multiple virtual networks can be mapped to a single internal virtual network identifier. Note that an RBridge needs to assign a unique internal virtual network identifier for a virtual network if the RBridge needs to forward packets to a customer on a local port. For example, an ingress or egress RBridge may assign a unique internal virtual network identifier for each virtual network whose packets are forwarded to a customer-facing port on the RBridge. However, if the RBridge is not an ingress or egress RBridge for a set of virtual networks, then the RBridge can map the set of virtual networks to a common “pass-through” internal virtual network identifier. For example, the RBridge can map multiple (VLAN identifier, VPN identifier) tuples to the same internal virtual network identifier if the RBridge is not an ingress or egress RBridge for these (VLAN identifier, VPN identifier) tuples.

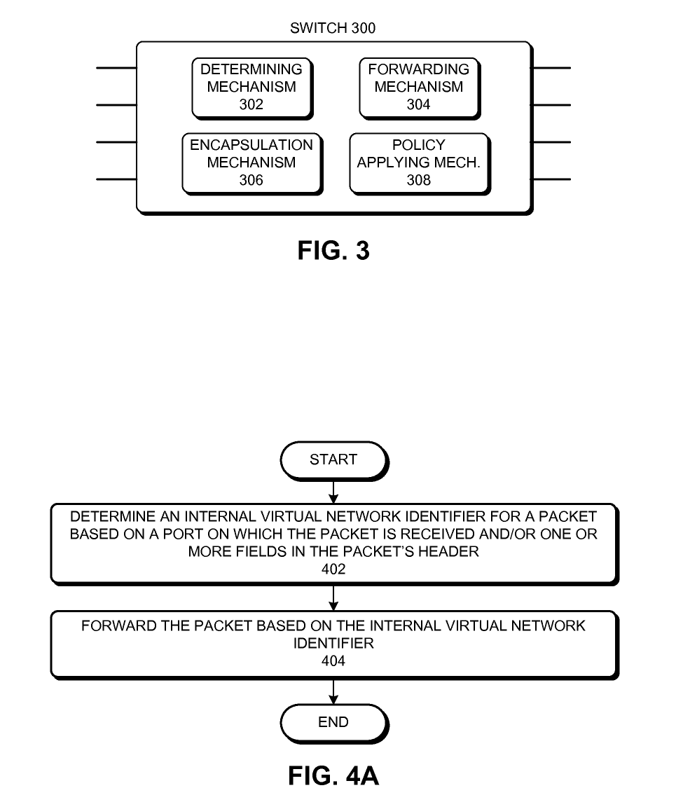

FIG. 3 illustrates a switch in accordance with some embodiments of the present invention.

Switch 300 can include a plurality of mechanisms which may communicate with one another via a communication channel, e.g., a bus. Switch 300 may be realized using one or more integrated circuits. In some embodiments, switch 300 is an RBridge (e.g., RBridge 102) which includes determining mechanism 302, forwarding mechanism 304, encapsulation mechanism 306, and policy applying mechanism 308. In some embodiments, these mechanisms may be part of an application-specific integrated circuit.

Determining mechanism 302 may be configured to determine an internal virtual network identifier and/or an internal policy identifier for a packet (e.g., Ethernet packet) based on the port on which the packet is received and/or one or more fields in the packet. Specifically, the fields in the packet's header that are used for determining the internal virtual network identifier and/or the internal policy identifier can include an S-VLAN-identifier, a C-VLAN-identifier, a VPN identifier, and/or one or more MAC addresses. The switch and/or port configuration can dictate which fields are used to determine the internal virtual network identifier and/or the internal policy identifier. For example, one port of a switch may be configured to map all packets to a particular internal virtual network identifier and/or a particular internal policy identifier. Another port of the switch may be configured to map a set of C-VLAN-identifiers to a corresponding set of internal virtual network identifiers and/or a corresponding set of internal policy identifiers, and assign a default internal virtual network identifier and/or a default internal policy identifier to a packet if the C-VLAN-identifier is not in the set of C-VLAN-identifiers.

Forwarding mechanism 304 may be configured to forward the packet based on the internal virtual network identifier. Specifically, forwarding mechanism 304 may include a table (e.g., an array in memory) which is indexed using the internal virtual network identifier. Each record in the table (e.g., an array element) can include information that indicates how to forward the packet. For example, the record may include a port identifier that identifies the outgoing port. The record may also include instructions and/or information for modifying one or more fields in the header (e.g., the record may indicate that VLAN translation is to be performed and specify the new VLAN identifier). Additionally, the record may include header fields that need to be added to the packet (e.g., a TRILL header and/or an S-tag).

Encapsulation mechanism 306 may be configured to encapsulate the packet in a TRILL packet. Specifically, encapsulation mechanism 306 may add a TRILL header to the packet to obtain a TRILL packet. In some embodiments, the packet header information can be used to determine the TRILL header that needs to be added to the packet. In other words, in these embodiments, the TRILL header and the internal virtual network identifier are determined concurrently. In some embodiments, the internal virtual network identifier can be used to determine the TRILL header that needs to be added to the packet (e.g., the record in the forwarding table may specify the TRILL header). Once the TRILL header has been added, the TRILL packet can be sent through the outgoing port.

In some embodiments, forwarding mechanism 304 or encapsulation mechanism 306 may be configured to add an S-tag (if one is not already present in the packet) to implement network virtualization. Specifically, if a packet received from a customer includes a C-tag, but not an S-tag, then the RBridge may add an S-tag to the packet to support network virtualization and/or partitioning within the TRILL network. The systems and techniques described in this disclosure can be used for implementing network virtualization and/or partitioning using either a VPN identifier embedded in the TRILL header or an S-tag.

In some embodiments, policy applying mechanism 308 can be configured to process the packet according to a policy associated with the internal policy identifier. Packets from different virtual networks can be mapped to the same internal policy identifier if the packets from these virtual networks are desired to be processed according to the same policy. A policy can generally include an arbitrary set of rules which specify how a packet is to be processed within the system. When a policy applying mechanism 308 processes a packet according to a given policy, the system can perform one or more actions, which can include, but are not limited to: dropping the packet, routing the packet over a particular link or path, and/or modifying information in the packet's header. The particular policy-based action that policy applying mechanism 308 performs for a packet can depend on information stored in the packet, and can override a forwarding decision that was made for the packet by forwarding mechanism 304.

Note that FIG. 3 is for illustration purposes only, and is not intended to limit the present invention to the forms disclosed. Specifically, in some embodiments, switch 300 may not be an RBridge, and/or may include fewer or more mechanisms than those shown in FIG. 3.

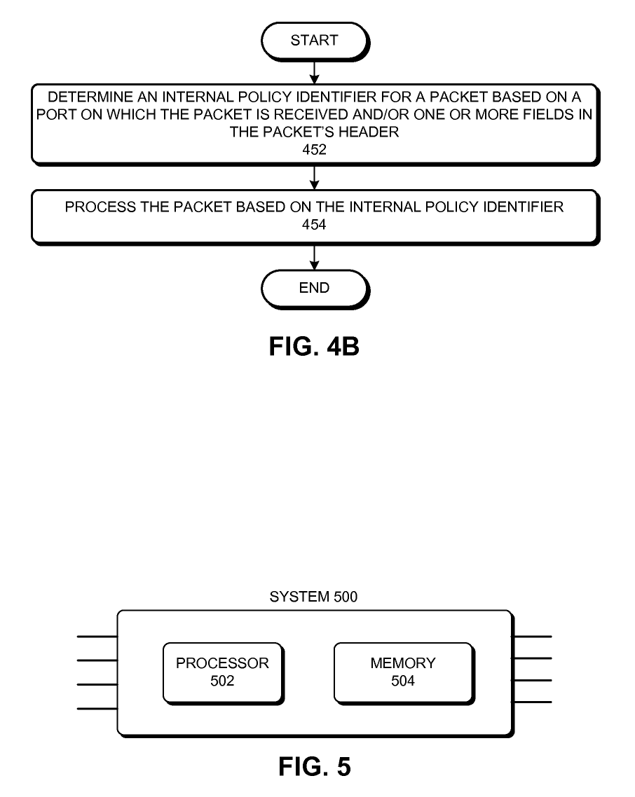

FIG. 4A presents a flowchart that illustrates a process for forwarding packets based on an internal virtual network identifier in accordance with some embodiments of the present invention.

The process can be performed by a switch, e.g., RBridge 102. Upon receiving a packet, the switch can determine an internal virtual network identifier for a packet based on a port on which the packet is received and/or one or more fields in the packet's header (operation 402). Specifically, the internal virtual network identifier can be determined based on a customer VLAN identifier, a service provider VLAN identifier, a source MAC address, and/or a VPN identifier. For example, the switch may determine the internal virtual network identifier by looking up the one or more fields in the packet's header in a context-addressable memory. If the lookup fails, the switch may assign a default internal virtual network identifier to the packet. A default internal virtual network identifier may be defined at one or more levels of granularity, e.g., on a virtual-network-wide or physical-network-wide basis, a system-wide basis, and/or on a per-port basis.

Next, the switch can forward the packet based on the internal virtual network identifier (operation 404). The switch can additionally encapsulate the packet in a TRILL packet by adding a TRILL header, and send the TRILL packet through the outgoing port which was determined based on the internal virtual network identifier.

FIG. 4B presents a flowchart that illustrates a process for applying a policy to a packet based on an internal policy identifier in accordance with some embodiments of the present invention.

The process can be performed by a switch, e.g., RBridge 102. Upon receiving a packet, the switch can determine an internal policy identifier for a packet based on a port on which the packet is received and/or one or more fields in the packet's header (operation 452). Specifically, the internal policy identifier can be determined based on a customer VLAN identifier, a service provider

VLAN identifier, a source MAC address, and/or a VPN identifier. For example, the switch may determine the internal policy identifier by looking up the one or more fields in the packet's header in a context-addressable memory. If the lookup fails, the switch may assign a default internal policy identifier to the packet. A default internal policy identifier may be defined at one or more levels of granularity, e.g., on a virtual-network-wide or physical-network-wide basis, a system-wide basis, and/or on a per-port basis.

Next, the switch can process the packet based on the internal policy identifier (operation 454). Processing the packet based on the internal policy identifier can involve performing one or more actions, which can include, but are not limited to: dropping the packet, routing the packet over a particular link or path, and/or modifying information in the packet's header. The particular policy-based action that is performed can depend on information stored in the packet, and can override a forwarding decision that was made for the packet based on an internal virtual network identifier.

FIG. 5 illustrates a system in accordance with some embodiments of the present invention.

System 500 can include processor 502 (e.g., a network processor) and memory 504. Processor 502 may be capable of accessing and executing instructions stored in memory 504. For example, processor 502 and memory 504 may be coupled by a bus. Memory 504 may store instructions that when executed by processor 502 cause system 500 to perform the process illustrated in FIGS. 4A and 4B. Specifically, in some embodiments, memory 504 may store instructions for determining an internal virtual network identifier and/or an internal policy identifier for a packet based on a port on which the packet is received and/or one or more fields in the packet's header, for encapsulating the packet in a TRILL packet by adding a TRILL header, for forwarding the packet based on the internal virtual network identifier, and/or for processing the packet based on the internal policy identifier.

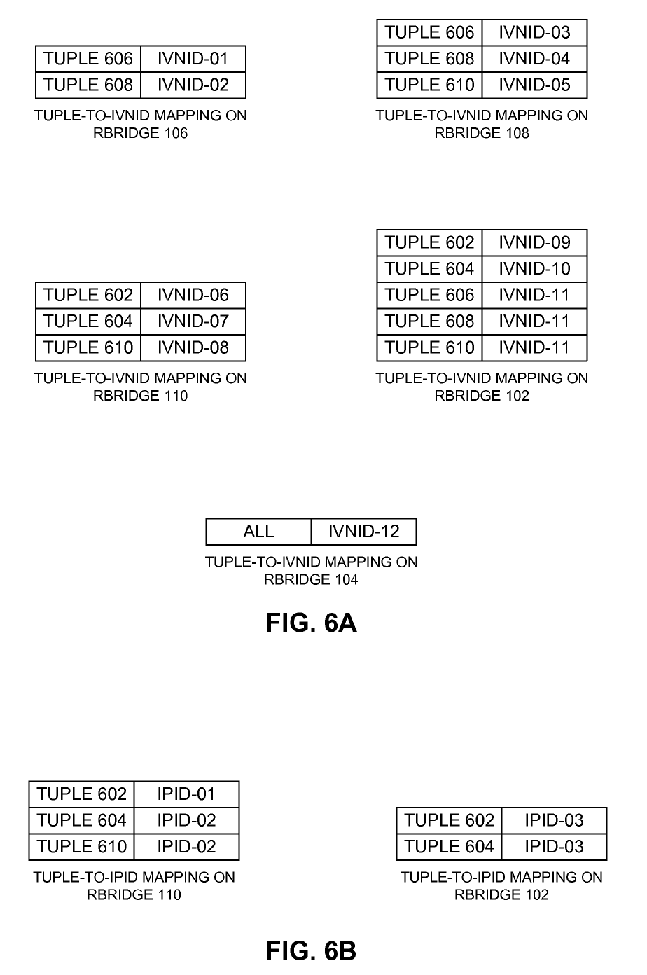

FIG. 6A illustrates examples of mappings between packet header information and internal virtual network identifiers in accordance with some embodiments of the present invention.

As mentioned above, the port on which a packet is received and/or one or more fields in the packet's header can be mapped to an internal virtual network identifier. The mappings shown in FIG. 6A map a (VLAN identifier, VPN identifier) tuple from a packet's header to an internal virtual network identifier. The mappings shown in FIG. 6 are for illustration purposes only and are not intended to limit the present invention to the forms disclosed.

The mappings illustrated in FIG. 6A may correspond to RBridges 102, 104, 106, 108, and 110 in FIG. 1. The mapping on RBridge 106 may map (VLAN identifier, VPN identifier) tuples 606 and 608 to internal virtual network identifiers IVNID-01 and IVNID-02, respectively. The mapping on RBridge 108 may map tuples 606, 608, and 610 to internal virtual network identifiers IVNID-03, IVNID-04, and IVNID-05, respectively. The mapping on RBridge 110 may map tuples 602, 604, and 610 to internal virtual network identifiers IVNID-06, IVNID-07, and IVNID-08, respectively.

The mapping on RBridge 102 may map tuples 602 and 604 to internal virtual network identifiers IVNID-09 and IVNID-10, respectively. If the traffic associated with tuples 606, 608, and 610 passes through RBridge 102, these tuples may be mapped to a common internal virtual network identifier, namely, IVNID-11. If all traffic passes through RBridge 104, the RBridge may map all tuples to a common internal virtual network identifier, namely, IVNID-12.

In some embodiments, the scope of internal virtual network identifiers does not extend beyond an RBridge. Hence, different RBridges may map the same tuple to different internal virtual network identifiers. For example, the tuple 606 is mapped to internal virtual network identifiers IVNID-01, IVNID-03, IVNID-11, and IVNID-12 on RBridges 106, 108, 102, and 104, respectively.

When RBridge 106 receives a packet on port P1 whose header information includes tuple 606, it can use the mapping shown in FIG. 6A to determine the associated internal virtual network identifier, namely, IVNID-01. Next, RBridge 106 can forward the packet based on IVNID-01. Specifically, RBridge 106 can perform a forwarding lookup using IVNID-01 as the key. The result of the lookup operation may indicate that a TRILL header is to be added to the packet to obtain a TRILL packet, and that the resulting TRILL packet is to be forwarded to RBridge 102. At RBridge 102, the TRILL packet may be forwarded to RBridge 108 based on the TRILL header.

Note that RBridge 102 may determine an internal virtual network identifier (e.g., IVNID-11) based on the header information. However, since the packet has a TRILL header, the internal virtual network identifier may be ignored by RBridge 102 for purposes of forwarding the packet (assuming that the packet is not destined for VLANs 112 or 114).

When the packet is received at RBridge 108, an internal virtual network identifier (e.g., IVNID-03) may be determined based on the header information. Next, the internal network identifier may be used to perform a forwarding lookup. The result of the lookup operation may indicate that the packet is to be forwarded on port P1 to VLAN 116. Accordingly, RBridge 108 may forward the packet on port P1 to VLAN 116.

FIG. 6B illustrates examples of mappings between packet header information and internal policy identifiers in accordance with some embodiments of the present invention.

As mentioned above, the port on which a packet is received and/or one or more fields in the packet's header can be mapped to an internal policy identifier. The mappings shown in FIG. 6B map a (VLAN identifier, VPN identifier) tuple from a packet's header to an internal policy identifier (IPID). In general, there is a one-to-one mapping between an internal policy identifier and a policy that is desired to be enforced. The mappings shown in FIG. 6B are for illustration purposes only and are not intended to limit the present invention to the forms disclosed.

The mappings illustrated in FIG. 6B may correspond to RBridges 102 and 110 in FIG. 1. The mapping on RBridge 110 may map (VLAN identifier, VPN identifier) tuples 602, 604, 610 to internal policy identifiers IPID-01, IPID-02, and IPID-02, respectively. The mapping on RBridge 102 may map tuples 602 and 604 to internal policy identifier IPID-03. Note that the same tuple may be treated differently (in terms of which policy is applied) by different RBridges. For example, RBridge 110 applies different polices to packets associated with tuples 602 and 604 (because, as shown in FIG. 6B, these tuples are mapped to different IPIDs), whereas RBridge 102 applies the same policy to packets associated with tuples 602 and 604. Further, an RBridge may apply the same policy to packets belonging to different virtual networks and/or customers. For example, tuples 604 and 610 may correspond to packets that belong to VLANs 114 and 120, respectively. As shown in FIG. 6B, RBridge 110 maps tuples 604 and 610 to the same IPID, i.e., RBridge 110 applies the same policy to packets from VLAN 114 (which belongs to customer C3) and VLAN 120 (which belongs to customer Cl).

The data structures and code described in this disclosure can be partially or fully stored on a non-transitory computer-readable storage medium and/or a hardware module and/or a hardware apparatus. A computer-readable storage medium includes, but is not limited to, volatile memory, non-volatile memory, magnetic and optical storage devices such as disk drives, magnetic tape, CDs (compact discs), DVDs (digital versatile discs or digital video discs), or other non-transitory media, now known or later developed, that are capable of storing code and/or data. Hardware modules or apparatuses described in this disclosure include, but are not limited to, application-specific integrated circuits (ASICs), field-programmable gate arrays (FPGAs), dedicated or shared processors, and/or other hardware modules or apparatuses now known or later developed. Specifically, the methods and/or processes may be described in a hardware description language (HDL) which may be compiled to synthesize register transfer logic (RTL) circuitry which can perform the methods and/or processes.

The methods and processes described in this disclosure can be partially or fully embodied as code and/or data stored in a computer-readable storage medium or device, so that when a computer system reads and/or executes the code and/or data, the computer system performs the associated methods and processes. The methods and processes can also be partially or fully embodied in hardware modules or apparatuses, so that when the hardware modules or apparatuses are activated, they perform the associated methods and processes. Further, the methods and processes can be embodied using a combination of code, data, and hardware modules or apparatuses.

The foregoing descriptions of embodiments of the present invention have been presented only for purposes of illustration and description. They are not intended to be exhaustive or to limit the present invention to the forms disclosed. Accordingly, many modifications and variations will be apparent to practitioners having ordinary skill in the art. Additionally, the above disclosure is not intended to limit the present invention. The scope of the present invention is defined by the appended claims.

What is claimed is:

1. A switch, comprising:
a determining mechanism configured to determine an internal virtual network identifier for a packet based on one or more fields of the packet; and
a forwarding mechanism configured to forward the packet based on the internal virtual network identifier.

2. The switch of claim 1, wherein the one or more fields in the packet include a customer VLAN (Virtual Local Area Network) identifier.

3. The switch of claim 1, wherein the one or more fields in the packet include a service provider VLAN (Virtual Local Area Network) identifier.

4. The switch of claim 1, wherein the one or more fields in the packet include a source MAC (medium access control) address.

5. The switch of claim 1, wherein the one or more fields in the packet include a VPN (Virtual Private Network) identifier.

6. The switch of claim 1, wherein the determining mechanism is configured to determine the internal virtual network identifier based on one or more fields in a packet and a port identifier associated with a port on which the packet is received.

7. The switch of claim 1, comprising an encapsulation mechanism configured to add a TRILL (Transparent Interconnection of Lots of Links) header to the packet.

8. The switch of claim 7, wherein the TRILL header includes a VPN (Virtual Private Network) identifier.

9. A system, comprising:
a processor; and
a memory storing instructions that when executed by the processor cause the system to perform a method, the method comprising:
determining an internal virtual network identifier for a packet based on one or more fields in the packet; and
forwarding the packet based on the internal virtual network identifier.

10. The system of claim 9, wherein the one or more fields in the packet include a customer VLAN (Virtual Local Area Network) identifier.

11. The system of claim 9, wherein the one or more fields in the packet include a service provider VLAN (Virtual Local Area Network) identifier.

12. The system of claim 9, wherein the one or more fields in the packet include a source MAC (medium access control) address.

13. The system of claim 9, wherein the one or more fields in the packet include a VPN (Virtual Private Network) identifier.

14. The system of claim 9, wherein the internal virtual network identifier is determined based on one or more fields in the packet and a port identifier associated with a port on which the packet is received.

15. The system of claim 9, wherein the method further comprises adding a TRILL (Transparent Interconnection of Lots of Links) header to the packet.

16. The system of claim 15, wherein the TRILL header includes a VPN (Virtual Private Network) identifier.

17. A network, comprising:
a source switch configured to:
determine a first internal virtual network identifier for a packet based on one or more fields in the packet;
encapsulate the packet in a TRILL (Transparent Interconnection of Lots of Links) packet by adding a TRILL header to the packet; and
forward the TRILL packet based on the first internal virtual network identifier;
an intermediate switch configured to:
receive the TRILL packet; and
forward the TRILL packet based on the TRILL header; and
a destination switch configured to:
receive the TRILL packet;
determine a second internal virtual network identifier for the packet encapsulated in the TRILL packet based on one or more fields in the packet; and
forward the packet based on the second internal virtual network identifier.

18. The network of claim 17, wherein the one or more fields in the packet include a customer VLAN (Virtual Local Area Network) identifier.

19. The network of claim 17, wherein the one or more fields in the packet include a service provider VLAN (Virtual Local Area Network) identifier.

20. The network of claim 17, wherein the one or more fields in the packet include a source MAC (medium access control) address.

21. The network of claim 17, wherein the TRILL header includes a VPN (Virtual Private Network) identifier.

22. A method, comprising:
determining an internal virtual network identifier for a packet based on one or more fields in the packet; and
forwarding the packet based on the internal virtual network identifier.

23. The method of claim 22, wherein the one or more fields in the packet include a customer VLAN (Virtual Local Area Network) identifier.

24. The method of claim 22, wherein the one or more fields in the packet include a service provider VLAN (Virtual Local Area Network) identifier.

25. The method of claim 22, wherein the one or more fields in the packet include a source MAC (medium access control) address.

26. The method of claim 22, wherein the internal virtual network identifier is determined based on one or more fields in the packet and a port identifier associated with a port on which the packet is received.

27. The method of claim 22, further comprising adding a TRILL (Transparent Interconnection of Lots of Links) header to the packet.

28. The method of claim 22, wherein the TRILL header includes a VPN (Virtual Private Network) identifier.

29. A switch, comprising:
a determining mechanism configured to determine an internal policy identifier for a packet based on one or more fields in the packet; and
a policy applying mechanism configured to process the packet based on the internal policy identifier.
